(19) United States
(12) Patent Application Publication
(10) Pub. No.: US 2021/0076824 A1
(43) Pub. Date: Mar. 18, 2021

(54) Assemblable wood brick

(71) Applicant: PRIME-WELL ENTERPRISES,INC., Taipei (TW)

(72) Inventor: Shih Kun Hsu, Taipei (TW)

(73) Assignee: PRIME-WELL ENTERPRISES,INC., Taipei (TW)

(21) Appl. No.: 16/974,069

(22) Filed: Sep. 21, 2020

(30) Foreign Application Priority Data
Sep. 25, 2019 (TW) 108134997

(51) Int. Cl. A47B 96/20; E04C 1/00

(52) U.S. Cl. CPC A47B 96/20; E04C 1/00

(57) ABSTRACT

Provided is an assemblable wood brick. A unit of wood brick is composed of five plates including a top plate, two opposite first lateral plates and two opposite second lateral plates. Dovetail tenons, dovetail sluts, sluts and protrusions are correspondingly defined on sides each of the five plates such that the five plates are securely and orthogonally connect to each other at their sides to form a brick unit having a space defined there-inside. In addition, blind hole(s) can be provided on the outer surface of each one of the five plates such that any two brick can stably connect to each other by a fixed member corresponding to and engaging into the holes. Several types of furniture and constructions can be formed by connecting suitable amount of the bricks. Further, blind holes can be defined on both top side and bottom side of the second lateral plates such that any two bricks can stably connect to each other by a fixed member corresponding to and engaging into the holes.

### FIELD OF INVENTION

The invention relates to an assemblable wood brick and, especially, to an hollow wood brick having a space in center thereof and composed of five plates securely connected by correspondingly dovetail tenons, dovetail sluts, sluts and protrusions respectively defined on sides of the five plates so that several types of furniture or constructions can be formed by connecting suitable amount of the bricks through suitable connection members.

### BACKGROUND OF INVENTION

Recently, it is getting more interesting for users to make carpenter works. Owing to lacking professional training, the users usually fail to make such works solely by themselves. Though prior art DIY furnitures, for example, 3D-printed furnitures or modulated furnitures are available right now, it is still uneasy to make such prior art furnitures without using plastic materials mixed therein. Additionally, such prior art furnitures also encounter a serious problem of very high cost. Owing to using plastic materials and high cost in the prior art DIY furnitures, they are not environmentally friendly and only have relatively lower utility.

Generally, it will not be a dream for users to combine several units of assemblable wood bricks in a way similar to Lego® bricks, if such bricks are made of stable and non-deformable wood plates through precisely designed and suitable processed, for example, milling, saw cutting, drilling and so on, such that the so-formed little units of assemblable wood bricks, with or without using additional fixed members (for example, glues), can be assembled or connected together by users at will to form any type of furniture as they wish.

Before the present invention was provided, several types of assemblable construction units that can be assembled by using dovetail joggling or other scarf ways on sides of the construction units were available, for example, U.S. Pat. No. 5,215,490 entitled “BUILDING BLOCK SET OF TENON ENGAGING EDGE CONNECTION MEMBERS” patented on Jun. 1, 1993. The main object of this patent is to provide a building block set. The building block set includes several first block members. Each member has first and second major planar surface parallel to each other to define a substantially uniform thickness. Each member has four mutually orthogonal sides defining four corners. Each side has several half thickness rectangular protrusions forming at least one rectangular notch having a width approximately the thickness of the first block member. However, due to connecting only by half thickness on edges, this prior art patent encounters a problem in terms of the connection strength.

Furthermore, this prior art patent defines four square hole having a length and a width approximately that of the full-thicknessed protrusions (see claim 2 and paragraph 2, volume 5 of the specification of the patent). It does not teach the use of addition connection means, for example, resin or glue, to enforce the connection strength among blocks.

Thirdly, the objects of this prior patent belong to the category of toys (International Class No. A63H 33/08) and, thus the sufficient strength for any resulted furniture composed by assembling the block members of this patent is not so concerned, without need to mention that this prior art patent does not teach any way or any reason to seek suitable environmentally friendly and stable materials to form such an assemblable block based on the need of sufficient strength for the resulted furniture.

### SUMMARY OF INVENTION

In view of the problems found in the above prior art, there is still a need for an assemblable brick that can provide sufficient post-assembling structural strength by securely connecting brick units so as to apply them to construction field or furniture field. Therefore, the inventor, through his long-term research and giant efforts, finally completed this invention of assemblable brick to resolve the problems found in the prior art block members.

One objective of the invention is to provide an assemblable wood brick that can be quickly assembled by users at will. The assemblable brick can include a top plate that can be made of an approximately-rectangle wood plate. The top plate can have a suitable longitudinal length, a suitable transversal width and a suitable and even thickness. The top plate can have four sides with two opposite longitudinal sides parallel extending in a longitudinal direction thereof and the other two opposite transversal sides parallel extending in a transversal direction thereof such that any two connecting adjacent sides of the four sides orthogonally connect to each other. The top plate can have two parallel opposite surfaces including a top surface and a bottom surface defined among its four sides. The two opposite longitudinal sides parallel extending in longitudinal direction can be of a same length and can be longer than or equal to the length of the two opposite transversal sides that are also the same in the length. The two longitudinal sides respectively can have at least one first dovetail tenon opposite to each other and the two transversal sides respectively can have at least one second dovetail tenon opposite to each other. The assemblable wood brick can include two first lateral plates of a same shape. Each one of the first lateral plates can be made of an approximately-square wood plate having four sides of a same length corresponding to the transversal width of the top plate and having a thickness equal to the thickness of said top plate such that any two adjacent connecting sides of the first lateral sides orthogonally connect to each other. The first lateral plates respectively can have two parallel surfaces including an outer surface and an inner surface defined among said four sides of each one of the two first lateral plates. The four sides of each one of said first lateral plates can include a top side, a bottom side parallel and opposite to the top side, a left side and a right side parallel and opposite to the left side. The two first lateral plates can be oppositely disposed with the top side of one of said first lateral plates connecting to one of the transversal sides of the top plate while the top side of the other one of the first lateral plates connects to the other one of the transversal sides of the top plate. The top side of each one of the first lateral plates can have at least one top dovetail slut corresponding to the at least one second dovetail tenon of the top plate connecting to the first lateral plate such that one of the transversally extending side of the top plate can securely and vertically connect to one of the first lateral plates by joggling the dovetail slut and the dovetail tenon corresponding to each other while the other transversally extending side of the top plate can securely and vertically connect to the other one of the first lateral plate by joggling the dovetail slut and the dovetail tenon corresponding to each other. The first lateral plates respectively can have at least one lateral slut defined on the left side and the right side such that the at least one lateral slut on the left side is opposite to the at least one lateral slut on the right side. The assemblable wood brick can include two second lateral plates of a same shape. Each one of the second lateral plates can be made of an approximately-rectangle plate. Each second lateral plate can have four sides including a top side extending in a longitudinal direction, a bottom side extending in the longitudinal direction. The top side and the bottom side are the same in length and the length of the top and bottom sides are the same as that of the longitudinal side of the top plate corresponding to the top and bottom sides. Each second lateral plate further can include two parallel transversal sides extending in a transversal direction. The two transversal sides are of the same length and are the same, in terms of length, as the left and right sides of the first lateral plates that are respectively corresponding to the two transversal sides. Any two adjacent connecting sides of the second lateral plates can orthogonally connect to each other. The second lateral plate further can have two surfaces including an outer surface and an inner surface defined among said four sides to define an even thickness of the same size as the thickness of the top plate and the first lateral plates. The second lateral plates respectively can include at least one dovetail slut defined on the top side and corresponding to the at least one dovetail tenon on one of said longitudinal side of the top plate. The second lateral plates respectively can include at least one protrusion defined on the transversal sides. The at least one protrusion of one of the transversal sides can correspond to the slut on the right or left side of one of the first lateral plate and the at least one protrusion of other the transversal sides can correspond to the right or left side of other first lateral plate. The two second lateral plates are oppositely disposed in which the top side of one second lateral plates can connect to one longitudinal side of the top plate and the top side of other second lateral plate can connect to other longitudinal side of the top plate by joggling the at least one dovetail slut defined on the top side of each one of said second lateral plates to the at least one dovetail tenon of the top plate corresponding thereto. One of the transversal sides of one second lateral plate can connect to a corresponding right or left side of one first lateral plates. Other transversal side of the one second lateral plate can connect to a corresponding right or left side of other second lateral plate. Meanwhile, one of transversal side of other second lateral plates can connect to a corresponding right or left side of other first lateral plate. Other transversal side of other second lateral plate can connect to a corresponding right or left of other second lateral plates such that two second lateral plates each securely and orthogonally connects to the top plate and the two first lateral plates by joggling corresponding sides thereof A space is formed inside the wood brick by orthogonally connecting corresponding sides each of the top plate, the first lateral plates and the second lateral plates.

The other objective of the invention is to provide an assemblable wood brick so that a user can easily and quickly assemble them at will. In the above mentioned wood brick, the top plate further can include at least one blind hole located on the top surface thereof such that the at least one blind hole of one of any two top plates corresponds to that of the other top plate of the any two top plates so as to stably connect the two top plates by a fixed member corresponding to the blind holes each of the two top plates. Additionally, the two second lateral plates respectively can include at least one blind hole located on its outer surface such that the at least one blind hole on the second lateral plate of one of any two wood bricks corresponds to the at least one blind hole on the second lateral plate of the other one wood brick of the any two bricks so as to stably connect the any two bricks by a fixed member corresponding to the at least one blind hole on said outer surface of each the any two wood brick. Furthermore, the first lateral plates respectively can include at least one blind hole on the outer surface such that the at least one blind hole on the first lateral plate of one of any two wood brick corresponds to that on the other one of the any two wood brick so as to stably connect the any two bricks by a fixed member corresponding to the blind holes on the any two bricks.

The at least one blind hole on the top plate can correspond to the at least one blind hole on the second lateral plate such that any two wood bricks can stably connect to each other by a fixed member corresponding to the at least one blind holes respectively on the second lateral plate and the top plate.

The at least one blind hole on the top plate can correspond to the at least one blind hole on the first lateral plate such that any two bricks can connect stably to each other by a fixed member corresponding to the blind hole.

The second lateral plates respectively can include at least one blind hole located on the top side extending in the longitudinal direction and at least one blind hole located on the bottom side extending in the longitudinal direction such that the at least one blind hole on the top side of one of any two bricks can correspond to the at least one blind hole on the bottom side of the other one of the any two bricks so as to stably connect the two bricks by a fixed member corresponding both the blind holes each on the top side and the bottom side.

The blind hole on the second lateral plate can correspond to the blind hole on the first lateral plate such that any two bricks can stably connect by a fixed member corresponding to both the blind hole.

Furthermore, in one embodiment in accordance with the invention, a filler, including an acoustic insulation member, a flame resistant foam and a fire stop mineral wool can be filled in the space formed inside the brick.

Additionally, in one embodiment in accordance with the invention, the brick can include at least one aperture formed there-through so as to accommodate an electric wire, a water pipe or a gas pipe.

The longitudinal length of the top plate can be two times of the transversal width. Both the top plate and the first lateral plates respectively can include at least two blind holes. The at least two blind holes on the top plate can correspond to the at least two blind holes on the first lateral plates so that any two brick can stably connect to each other by two fixed members corresponding to the blind holes.

Another objective of the invention is to provide an assembalble wood brick that a user can easily can quickly assemble the brick without limitation by a narrow space in which the brick is to be piled. Therefore, the space-unlimited wood brick can be similar to the above mentioned bricks expect that the longitudinal length of the top plate can be at least three times (for example four times, five times or more times) of the transversal width thereof and the longitudinal length of the second plates can correspondingly be at least three times (or four times, five times or more times) of the transversal width thereof.

In another aspect of the invention, the longitudinal length of the top plate is equal to the transversal width thereof and meanwhile, the longitudinal length of the second lateral plates is equal to the transversal width thereof. Both the top plate and the second lateral plate can have a same length in longitudinal direction and transversal direction.

### BRIEF DESCRIPTION OF DRAWINGS

For better understanding of the technology, objectives and effects according to the invention, embodiments in accordance with the invention are described accompanying with the drawings in followings.

FIG. 1 is a three dimensional view of the wood brick in accordance with the invention.

FIG. 2 is an exploded view of the wood brick in accordance with the invention.

FIG. 3 is a section view in longitudinal direction of the wood brick in accordance with the invention.

FIG. 4 is a section view in the longitudinal direction of the wood brick in accordance with the invention, wherein the space inside the brick was filled with a filler.

FIG. 5 is a three dimensional view of the wood brick in accordance with the invention, wherein blind holes respectively were defined on outer surfaces each of the plates.

FIG. 6 is an exploded view of the wood brick in FIG. 5.

FIG. 7 is a three dimensional view of the wood brick in accordance with the invention, wherein two bricks aligned in perpendicular direction to overlap to each other.

FIG. 8 is a three dimensional view of the wood brick in accordance with the invention, wherein two bricks partially lapped in perpendicular direction.

FIG. 9 is a three dimensional view of the wood brick in accordance with the invention, wherein two bricks partially lapped to form a 90° angle between the longitudinal directions each of the two bricks.

FIG. 10 is a three dimensional view of the wood brick in accordance with the invention, wherein two bricks aligned in horizontal direction to overlap the first lateral plates each of the two bricks.

FIG. 11 is a three dimensional exploded view of the wood brick in accordance with the invention, wherein two bricks lapped in horizontal direction with a second lateral plate of one brick aligning a first lateral plate of the other brick.

FIG. 12 is a three dimensional view of the wood brick in accordance with the invention, wherein two bricks overlapped in horizontal direction with a second lateral plate of one brick aligning a second lateral plate of the other brick.

FIG. 13 is a three dimensional view of the wood brick in accordance with the invention, wherein two bricks lapped by the top plate of one brick aligning a first lateral plate of the other brick in perpendicular direction.

FIG. 14 is a front view of the other example of the wood brick in accordance with the invention, wherein the length of the top plate is 50% cut off.

FIG. 15 is a front view of another example of the wood brick in accordance with the invention, wherein the length of the top plate is elongated more than ⅓ of original length.

### DETAILED DESCRIPTION OF INVENTION

Now, descriptions of preferred embodiments in accordance with the invention, together with accompanying drawings will be illustrated in followings.

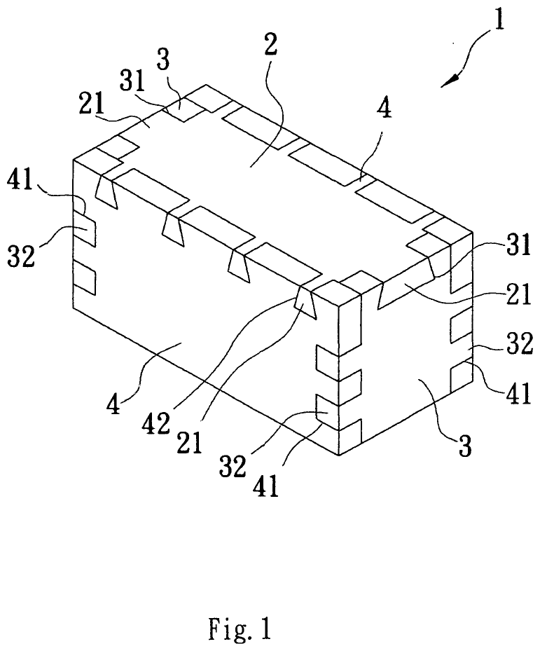

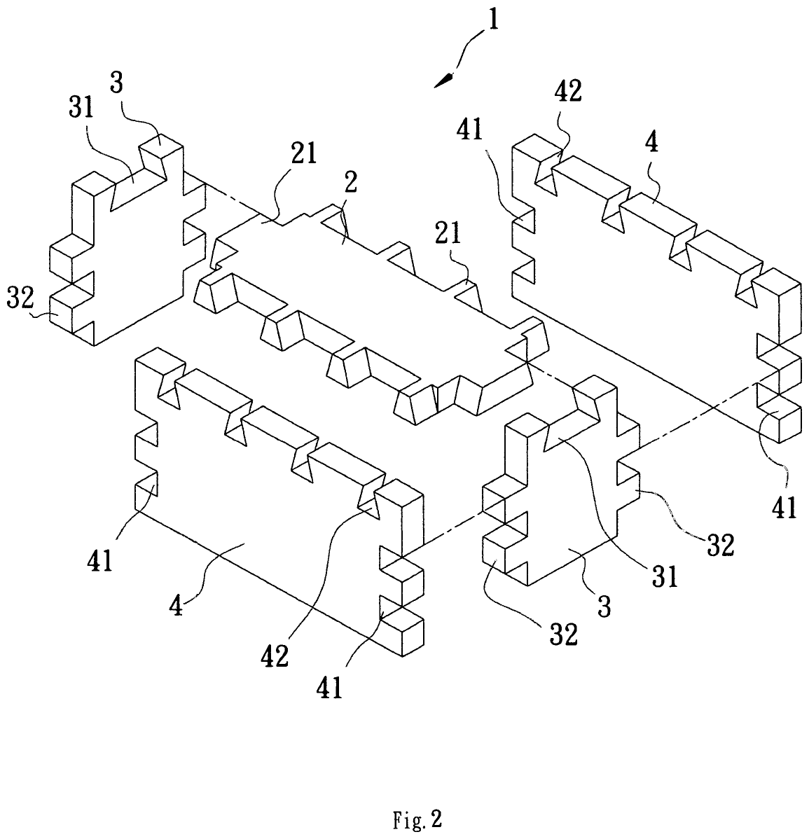

Referring to FIGS. 1, 2 and 3, the assemblable wood brick (1) in accordance with the invention was composed of five wood plates. The wood plates can include a top plate (20), two first lateral plates (30) and two second lateral plates (40). The top plates (20), the first lateral plates (30) and the second plates (40) respectively can be made of a solid wood or a multi-layered plywood, for example, a moisture-resistant plywood laminated by insect proofing thin core-boards that have a suitable thickness, for example, 15 mm in thickness. Each plate of the brick (1) can include a suitable amount of joggling elements. Thereby, the wood brick (1) assembled by the five plates (the modes for assembling the plates into a brick will be detailed in following) can be characterized by its tough and stable appearance and by its durability. As a result, the assembable wood brick (1) additionally can acquire other characteristics to allow nailing, drilling, panting, milling, adhering, and filling on its surface. Additionally, any damaged plate unit of the brick (1) can be replaced easily to greatly reduce preparing cost and time.

As shown, the top plate (20) is an approximately rectangle wood plate having orthogonally connected four sides, that is, two longitudinal opposite sides extending in its longitudinal direction (L) and two transversal sides extending in its width direction (W). A top surface and a bottom surface (not shown) were surrounded by the four sides so as to make an even thickness of the plate. The top plate (20) can have a suitable length in its longitudinal direction, a suitable width in its transversal direction and a suitable thickness. The length of the top plate (20) can be longer than or equal to the width of the top plate (20) and the width can be greater than the thickness. Preferably, the length in longitudinal direction of the top plate (20) can be two times of that of the width in transversal direction, and the top plate (20) is homogenous in terms of thickness across its whole surface. At least one joggling element, (for example, a dovetailed tenon, a dovetailed slut, a protrusion or a slut), can be defined on each one of the four sides of the top plate (20) (as will be detailedly described in followings). More particularly, the top plate (20) can include at least one longitudinal side tenon (210) and at least one transversal side tenon (211).

As shown, the two first lateral plates (30) can be of the same form and size. The first lateral plates (30) were approximately in form of a square having four sides orthogonally connecting one by one. An outer surface and an inner surface can be defined by the surrounding four sides of each first lateral plate (30) so as to make an even thickness of the plate body. The length of each first lateral plate (30) can correspond to the transversal width of the top plate (20). Except for the bottom side, each first lateral plate (30) can include at least one joggling element such as a dovetailed tenon, a dovetailed slut, a protrusion and a slut respectively on its top, left (1) and right (r) sides (as will be detailedly described in followings). Additionally, the thickness of each first lateral plate (30) can correspond to that of the top plate (20).

As shown, the two first lateral plates (30) of the same form and size respectively can be located to connect the opposite two shorter transversal sides of the top plate (20). The two first lateral plates (30) respectively can connect to one shorter side of the top plates (20) to form an angle of 90° at the connected interface (as will be detailedly described in followings). The two first lateral plates (30) respectively can include a top side such that each top side can connect to one transversal side of the top plate (20). Each first lateral plate (30) can include a right side (r) and left side (1). On the top side of each first lateral plate (30), at least one top side dovetailed slut (31) can be defined to correspond to the at least one second dovetailed tenon (211) of the top plate (20). That is, the dovetailed slut (31) of one second lateral plate (30) will correspond to one second dovetailed tenon (211) on one side of the top plate (20) and meanwhile the dovetailed slut (31) of other second lateral plate (30) will correspond to the dovetailed tenon (211) on other side of the top plate (20). Because that the side length of each first lateral plate (30) is the same as that of the transversal width of the top plate (20), that the thickness of these plates (20, 30) and that each second dovetailed tenon (211) of the top plate (20) can securely insert into one top side dovetailed slut (31) of the first lateral plate (30), a stable and intimate 90° connection can be formed between the interface between sides of the top plate (20) and the first lateral plate (30) that connect to each other. Furthermore, the right side and the left side of the first lateral plates (30) respectively can include at least one opposite side slut (32).

As shown, the two second lateral plates (40) are of the same form and size. Each second lateral plate (40) is of an approximately rectangle form having four sides orthogonally connecting to each other, including two opposite longitudinal sides extending in its longitudinal direction (L) and two opposite transversal sides extending in its width direction (W). A top surface and a bottom surface (not shown) respectively can be defined by the four surrounding sides of the second lateral plates (40) so as to form an even thickness of the plate body. The longitudinal length of the second lateral plate (40) can correspond to the longitudinal length of the top plate (20) and the transversal width of the second lateral plate (40) can correspond to the transversal width of the top plate (20) and therefore correspond to the side length of the first lateral plate (30). The thickness of the second lateral plate (40) is also uniformed and can correspond to the thickness of the top plate (20) and therefore can correspond to that of the first lateral plate (30). Each second lateral plate (40) can have at least one suitable joggling element such as a dovetailed tenon, a dovetailed slut, a protrusion or a slut (as will be detailedly described in followings).

As shown, each second lateral plate (40) can include a longitudinal top side and two shorter opposite transversal sides. The longitudinal top side of the second lateral plate (40) include at least one top side dovetailed slut (42) that corresponds to the at least one first dovetailed tennon (210) of the top plate (20). Because that the longitudinal length of the second lateral plate (40) is the same as the longitudinal length of the top plate (20), that the second lateral plate (40) and the top plate (20) are of the same thickness, and that the first dovetailed tenon (210) of top plate (20) can stably insert into the dovetailed slut (42) of the second lateral plate (40), a stable and intimate 90° connection can be formed on the interface between sides of the top plate (20) and the second lateral plate (40) that connect to each other.

As mentioned in above, each second lateral plate (40) can include two opposite shorter side extending in the transversal direction. At least one transversal side slut (41) can be defined on the transversal extending shorter side of the second lateral plate (40). One transversal side slut (41) of one second lateral plate (40) can correspond to one of the right and left side tenons (32) of one first lateral plate (30) and one transversal side slut (41) of the other second lateral plate (40) can correspond to the other one of the right and left tenons (32) of the same first lateral plate (30).

Meanwhile, one transversal side slut (41) of the other second lateral plate (40) can correspond to one of the right and left side tenons (32) of the other first lateral plate (30) and the other transversal side slut (41) of the other second lateral plate (40) can correspond to the other one of the right and left side tenons (32) of the same first lateral plate (30). Therefore, a securely 90° connection can be formed on the interface between any pair of connecting sides of two first lateral plates (30) and two second lateral plates (40) by stably and intimately inserting the right and left side tenons (32) of the first lateral plates (30) each into one of the sluts (41) of the second lateral plates (40) that correspond to the tenons (32). Because the transversal width of the second lateral plates (40) is equal to the width of the first lateral plates (30) and the first and second lateral plates (30, 40) are the same in terms of thickness, the connecting sides between these two plates can securely and intimate engage together by orthogonally joggling the sluts (41) and corresponding protrusions (32).

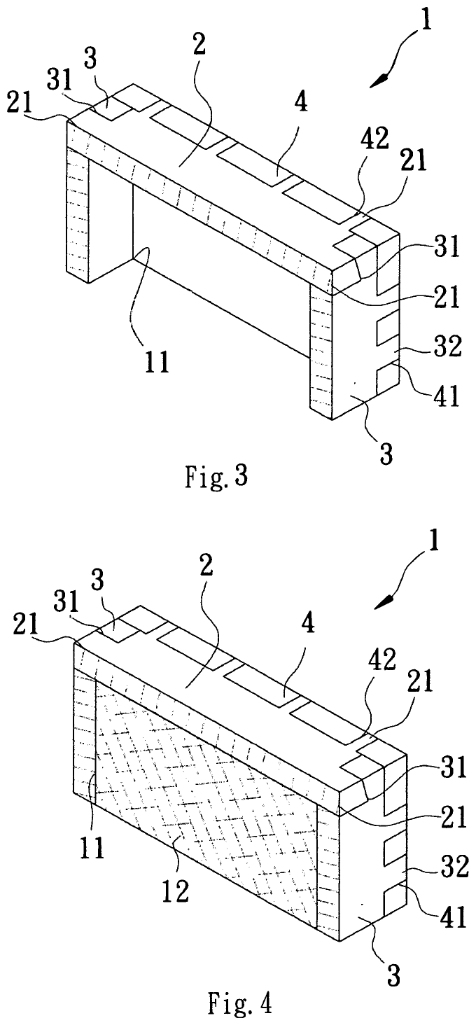

As above mentioned, because that a securely and intimate perpendicular (90°) connection on the interface between sides each of the top plate (20) and the first lateral plates (30) can be formed; that the other securely and intimate perpendicular connection of sides each of the top plate (20) and the second lateral plates (40) can be formed; and that another securely and intimate perpendicular connection of sides each of the first lateral plates (30) and the second lateral plates (40) can be formed, the unit of assemblable wood brick (1) made of the five plates (20, 30 and 40) is in form of rectangle (See FIG. 1). In this embodiment, both the longitudinal length and the transversal width of each plate (20, 30 and 40) are larger than the thickness thereof, and thus a space (11) can be formed in the center inside the brick (1) after the perpendicularly connection of sides each of the five plates (20, 30 and 40) is completed (See FIG. 3).

Optionally, an environmentally friendly adhesive (not shown), such as the low aldehyde glue conforming to the National Standards F3 (Republic of China (ROC)) can be coated on the dovetailed tenons, dovetailed sluts, protrusions and sluts respectively defined on sides each of the five plates (20, 30 and 40) to enforce the connection strength among these sides.

As will be mentioned in followings, several units of the assemblable wood brick (1), similar to the prior art building bricks, can be connected together. The connection forms of the bricks (1) can include plural overlapping or lapping forms in longitudinal direction or transversal direction of bricks (1). A fixed member (not shown) such as environmentally friendly glue can further be coated on connection site among bricks (1) so as to stably construct any furniture, wall, floor or other articles needed by users.

Optionally, the above mentioned five plates (20, 30 and 40) of the brick (1) can be made of light-weighted multilayered plywood, and preferably the moisture-resistant plywood laminated by insect proofing thin core-boards that have a suitable thickness, for example, 15 mm in thickness. Therefore, the resulted brick (1) can possess a tough and stable appearance and can acquire good durability. The so-resulted brick (1) can further acquire characteristics to allow nailing, drilling, panting, milling, adhering, and filling on its surface. Additionally, any damaged plate (20, 30 or 40) unit of the brick (1) can be replaced to greatly reduce preparing cost and time.

The bricks (1) connection by using the fixed member can allow a precise and intimate connection interface between any two bricks (1) and allow the connected bricks (1) to detach from each other and then to rearrange so as to acquire characteristics in terms of low environmental pollution and quick re-assembling.

Now, referring to FIG. 4, one embodiment in accordance with the invention can provide an assemblable wood brick (1) with greater rigidity. As shown, a suitable filler (12), such as acoustical glue, flame-resistant foam and expanded graphite can be filled in the space (11) of the brick (1). Therefore, in addition to increased rigidity, the filled brick (1) can further have increased acoustic or flame-resistant ability or both.

One embodiment in accordance with the invention, optionally, can provide an assemblable wood brick (1) including an electric wire, a water pipe (not shown) or other pipelines hidden therein. To bury the electric wire into the brick (1), the water pipe or other pipelines in the brick (1), additional apertures (not shown) can be defined to run through the whole body of the above mentioned brick (1). That is, apertures can be drilled through the brick (1) to allow the pipelines, for example, electric wire, water pipe, gas pipe and so on to pass there-through so as to deliberately conceal the pipelines without adversely affecting the aesthetics appearance of the brick (1).

Optionally, in one embodiment in accordance with the invention, the dovetailed tenons and sluts respectively defined on the top plate (20) and first lateral plates (30) of the brick (1) can be formed by, for example, milling with a formed cutter. Meanwhile, the sluts and protrusions respectively defined on the second lateral plates (40) and the first lateral plates (30) can be formed by, for example, cutting with an end mill, a wire saw or a band saw.

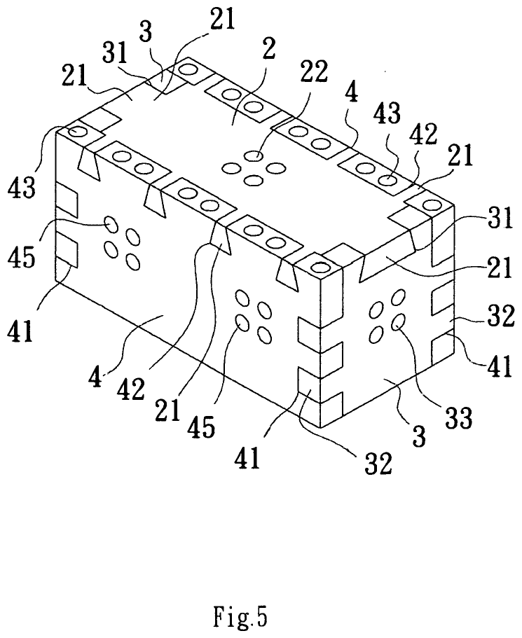

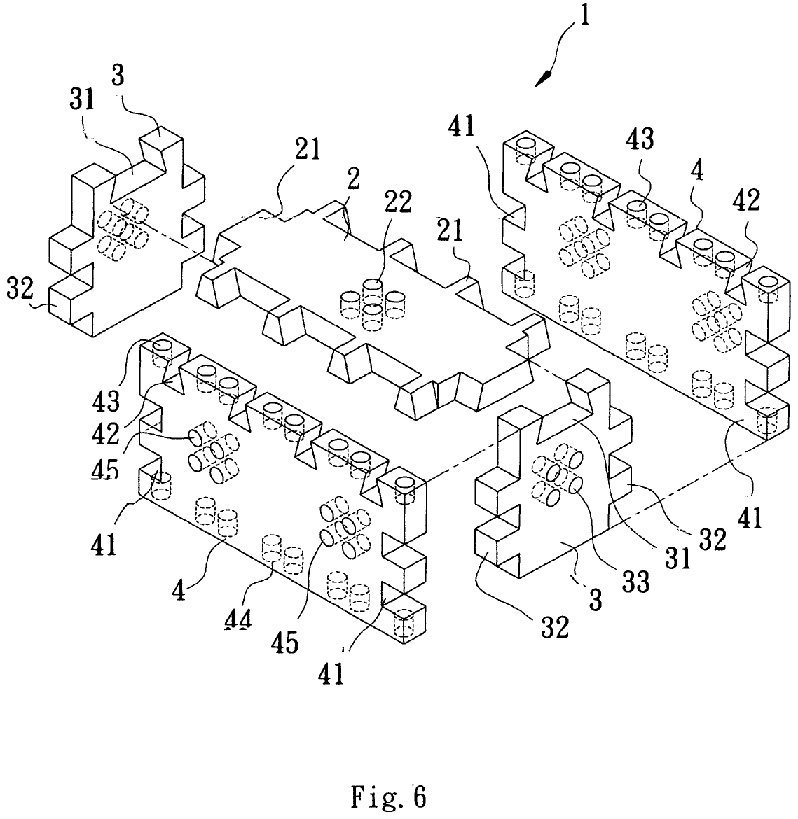

Now referring to FIG. 5 and FIG. 6, other embodiment in accordance with the invention provides an assemblable wood brick (1) that can include at least one blind hole defined on its surface or sides of each plates (20, 30 and 40). Except for these blind holes, the wood brick (1) shown in FIGS. 5 and 6 is similar to the brick (1) of FIGS. 1, 2 and 3 (as will be detailedly described in followings). Furthermore, to combine any two holes-containing bricks (1), further fixed members that are suitable to insert into the holes respectively defined on the two bricks (1) can be provided to correspond the holes defined on the any two bricks (1) so as to provide a totally physical connection between the two bricks (1) such that a quickly position-able and totally-orderly connection between any pair of the two bricks (1), wholly overlapping or partially lapping to each other in perpendicular or horizontal direction, can be achieved (as will be detailed in followings).

As shown in FIGS. 5 and 6, at least one blind hole (22), and preferably a set of four blind holes (22), can be defined on the top surface of the top plate (20) of the brick (1). To connect any two bricks (1), the blind holes (22) set on one brick (1) can correspond to the blond holes (22) set on the other brick (1). A fixed member set (not shown) can further be provide to correspond these blind holes (22) sets respectively defined on the two bricks (1) to insert into each corresponding holes (22) set so as to provide a stably physical connection between the two bricks (1) (as will be more detailedly described in followings).

As shown, at least one blind hole (45), and preferably a set of four blind holes (45), can be defined on the outer surface of each second lateral plate (40). To connect any two bricks (1), the blind holes (45) set of one brick (1) can correspond to the blind holes (45) set on other brick (1) and a fixed member set (not shown) can be further provided to insert into each corresponding blind holes (45) set to achieve a stable physical connection between these two bricks (1).

As shown, at least one blind hole (33) can be defined on the outer surface of each first lateral plates (30), and preferredly a set of blind holes (33) including four holes (33). To connect two bricks (1), the blind holes (33) set on one first lateral plate (30) of the two bricks (1) can correspond to the blind holes (33) set of other brick (1). Therefore, the two bricks (1) can be stably connected by a fixed member set (not shown) inserting into corresponding blind holes (33) set respectively defined on these two bricks (1).

As shown, to connect two bricks (1), at least one blind hole (43) can be defined on the longitudinal top side of the second lateral plates (40) and at least one blind hole (44) can be defined on the longitudinal bottom side of the second lateral plates (40). Preferredly, the at least one blind hole (43) on the longitudinal top side includes a set of eight blind holes (43) defined on the dovetailed tenons (42). Preferable, the at least one blind hole (43) on the longitudinal bottom side includes a set of eight blind holes (43) corresponding the blind holes (43) set on the top side. To assembly any two bricks (1), the set of blind holes (43) on the longitudinal top side of the second lateral plate (40) of one brick (1) can correspond to the set of blind holes (44) on bottom side of the second lateral plate (40) of other brick (1). Meanwhile, a fixed member set (not shown) can be used to insert into each set of the blind holes (43, 44) to connect the two bricks (1) (as will more detailedly described in followings). In addition, to connect any two bricks (1), blind holes (45) set on the outer surface of each second lateral plate (40) of one brick (1) can correspond to the blind holes (33) set on the outer surface of the first lateral plate (30) of other brick (1). Therefore, the two bricks (1) can be connected together through the corresponding blind holes (45, 33) sets by inserting a fixed member set (not shown) into to each corresponding holes set with one end of one fixed member engaged in one blind hole (45) and the other end of the fixed member engaged in one blind hole (33).

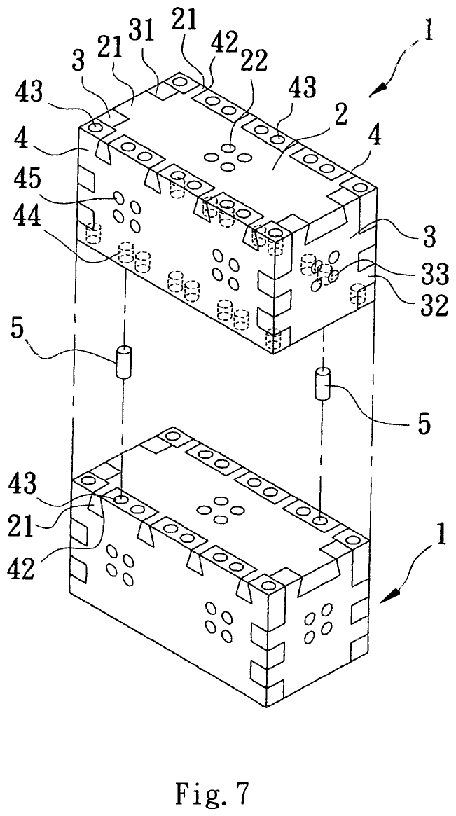

Please refer to FIGS. 5, 6 and 7. The shown embodiment in accordance with the invention includes two brick (1) and at least one fixed member (50) capable of providing physical connection between these two bricks (1). The fixed member (50) can be suitably shaped to correspond to the shape of the blind holes (33, 43, 44 and 45) respectively defined on the outer surfaces of the top and the first lateral plates and the top and the bottom sides of the second plates (40). As a result, any two bricks (1) can be connected to each other in horizontal and perpendicular directions, totally overlapped or partially lapped through inserting the ends of the fixed member into corresponding blind holes (33, 43, 44 and 45). For the sake of explaining the invention, only two bricks (1) and two fixed members (50) were illustrated in drawings. However, those skilled in the art will understand that the invention is not limited to these two bricks (1) and members (50). Instead, the invention can include more than two bricks (1) or members (50) in bricks-connected form, such as three, four, five or more bricks or members (50).

As shown, a set of several blind holes (43) was defined on the top side of the second lateral plate (40) of one brick (1) and a set of several blind holes (44) was defined on the bottom side of the second lateral plate (40) of other brick (1). As the above, blind holes (43) set can correspond to blind holes (44) set. Preferably, the blind holes (43, 44) respectively can include a form of cylinder having suitable diameter and depth that will not affecting the whole strength of the second lateral plates (40). Furthermore, the at least one fixed member (50) also can provide with a cylinder form corresponding to the form of blind holes (43, 44). At the same time, the fixed member (50) can have a suitable diameter and length such that the fixed member (50) can insert into the blind holes (43, 44) with one end engaging into one of the holes (43, 44) and other end engaging into other one of the holes (43, 44). Thus, the two bricks (1) can be intimately and stably overlapped in the perpendicular direction. Preferably, the fixed member (50) is in form of a wood pin. It should be noted that many suitable forms for the blind holes can be used in the invention, for example, three-sides column, rectangular column, elliptical column and so on. Accordingly, the corresponding shape will be adapted on the fixed member (50) if the form of the holes (43, 44) changes.

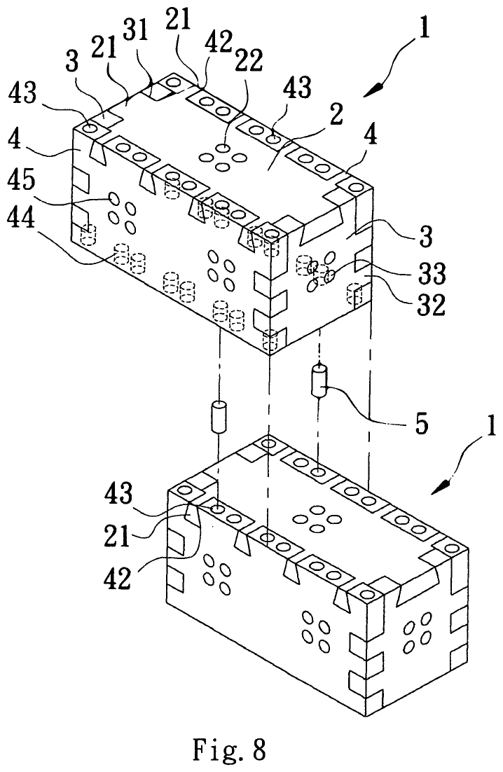

Referring to FIGS. 5, 6 and 8, two bricks (1) were partially lapped perpendicularly in longitudinal direction. In this embodiment, fixed members (50) can be used to respectively insert into the corresponding top side blind holes (43) on one brick (1) and the bottom side blind holes (44) on other brick (1). For the sake of explaining the invention, two bricks (1) were illustrated in drawings. However, those skilled in the art will understand that the invention is not limited to these two bricks (1). Instead, the invention can include more than two bricks (1) in bricks-connected form, such as three, four, five or more bricks. As result, a wall structure can be formed by connecting suitable amounts of brick (1) by employing the above connection form.

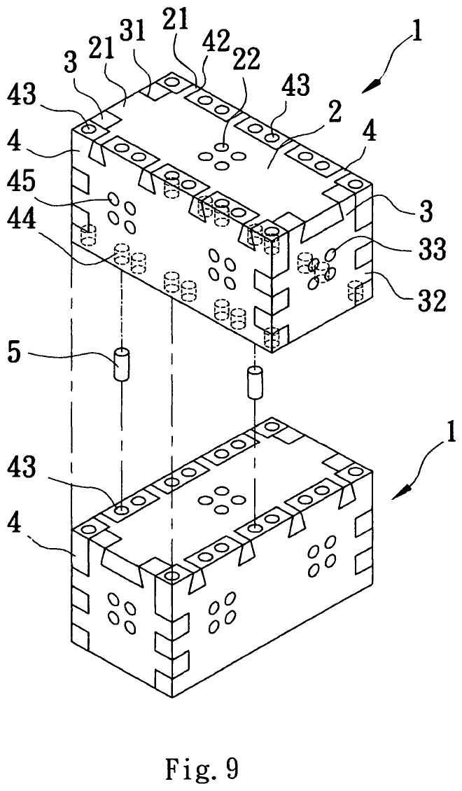

Please refer to FIGS. 5, 6 and 9. In one embodiment in accordance with the invention, two bricks (1) were partially lapped to form a 90° angle between the longitudinal and transversal directions each of the two bricks (1). In this connection form, the fixed members (50) also were used to insert into the corresponding top side blind holes (43) on one brick (1) and the bottom side blind holes (44) on the other brick (1). For the sake of explaining the invention, two bricks (1) were illustrated in drawings. However, those skilled in the art will understand that the invention is not limited to these two bricks (1). Instead, the invention can include more than two bricks (1) in bricks-connected form, such as three, four, five or more bricks.

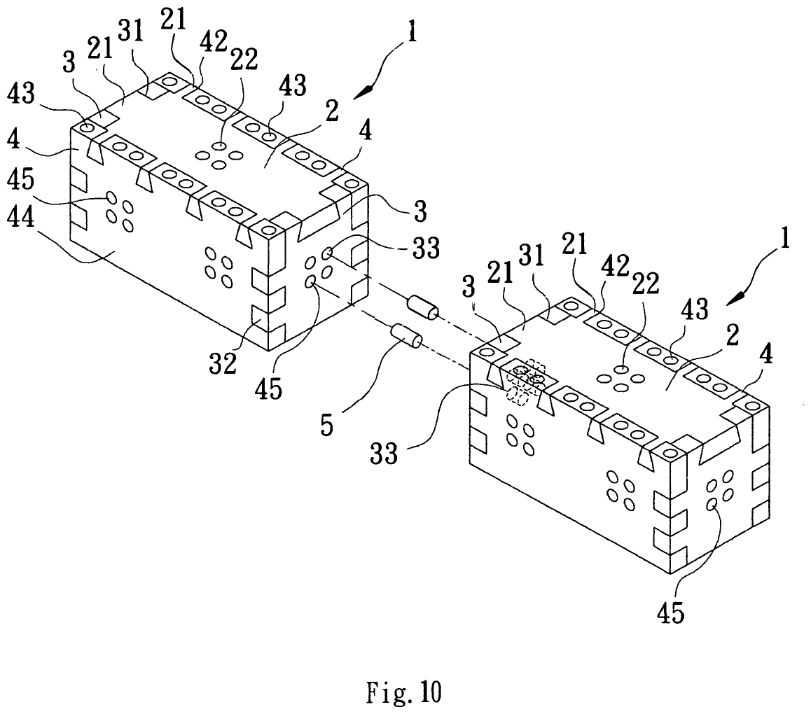

Now referring to FIGS. 5, 6, and 10, in one embodiment in accordance with the invention, two bricks (1) aligned each other by their transversal sides in horizontal direction so that the blind holes (33) on one first lateral plate (30) can correspond to the blind holes (33) on other first lateral plate (30). With corresponding fixed members (50) respectively inserting into these blind holes (33) to engage in the holes (33) respectively defined on the two bricks (1), the two bricks (1) can be stably and intimately connected together. For the sake of explaining the invention, two bricks (1) were illustrated in drawings. However, those skilled in the art will understand that the invention is not limited to these two bricks (1). Instead, the invention can include more than two bricks (1) in bricks-connected form, such as three, four, five or more bricks.

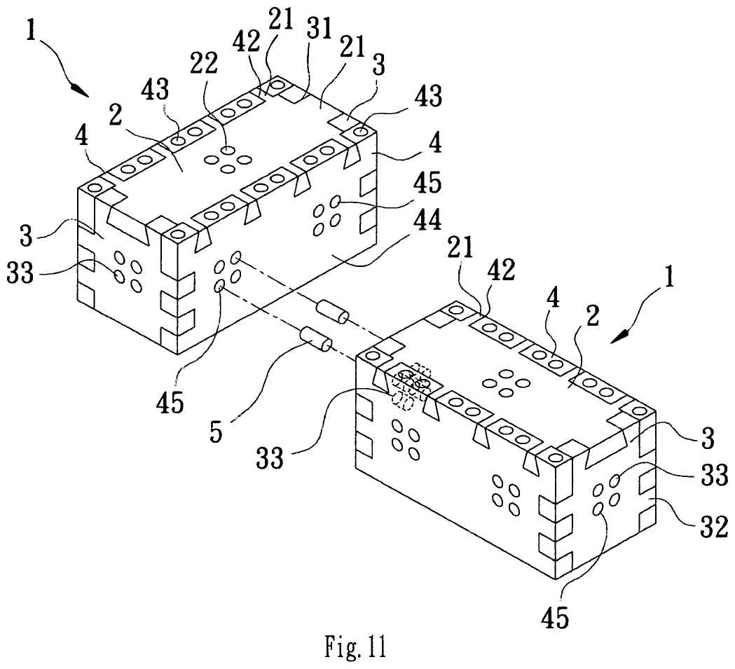

Now referring to FIGS. 5, 6 and 11, in one embodiment in accordance with the invention, two bricks (1) were lapped in horizontal direction with a second lateral plate (40) of one brick (1) aligning a first lateral plate (30) of other brick (1). In this embodiment, fixed members (50) were used to insert into the corresponding blind holes (33, 45) each defined on the plates (30, 40) such that the two bricks (1) can stably and intimately connect to each other. For the sake of explaining the invention, two bricks (1) were illustrated in drawings. However, those skilled in the art will understand that the invention is not limited to these two bricks (1). Instead, the invention can include more than two bricks (1) in bricks-connected form, such as three, four, five or more bricks.

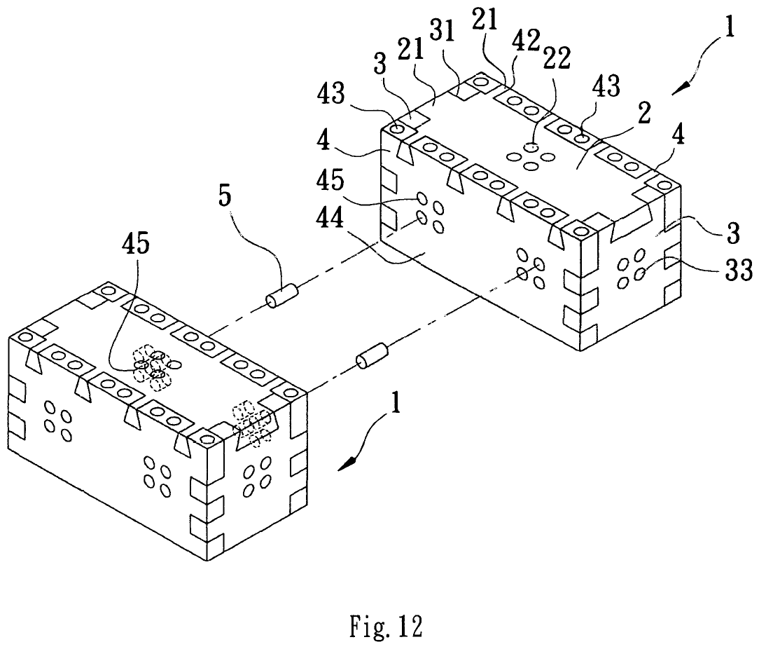

Please refer to FIGS. 5, 6 and 12. In this embodiment in accordance with the invention, two bricks (1) were overlapped in horizontal direction with the second lateral plate (40) of one brick aligning the second lateral plate (30) of other brick (1). Corresponding fixed members (50) also were used to engage in holes (45) respectively defined on the two bricks (1). For the sake of explaining the invention, two bricks (1) were illustrated in drawings. However, those skilled in the art will understand that the invention is not limited to these two bricks (1). Instead, the invention can include more than two bricks (1) in bricks-connected form, such as three, four, five or more bricks.

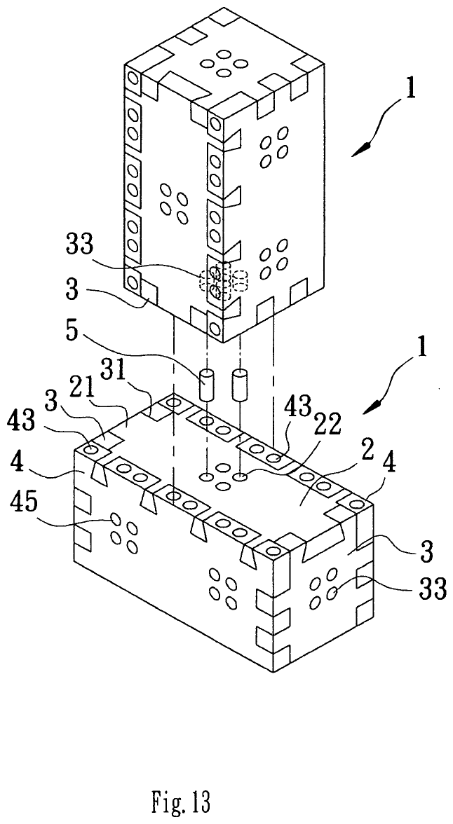

Referring to FIGS. 5, 6 and 13, two wood bricks (1) in accordance with the invention were lapped to each other. In this embodiment, the top plate (20) of one brick (1) can align the first lateral plate (30) of other brick (1) in perpendicular direction. Corresponding fixed members (50) also were used to engage in holes (45) respectively defined on the two bricks (1). For the sake of explaining the invention, two bricks (1) were illustrated in drawings. However, those skilled in the art will understand that the invention is not limited to these two bricks (1). Instead, the invention can include more than two bricks (1) in bricks-connected form, such as three, four, five or more bricks.

The suitable fixed member (50) can include, for example, wood pin, spring pin, wood screw, environmentally friendly glues and so on. Using the fixed member (50) enables any two connected bricks (1) to achieve precisely position and intimately connection and to allow them to be quickly and easily detachable and rearrange-able. Therefore, characteristics in terms of quick assembling and detachment of bricks (1) together with low environmental pollutions can be achieved by using the suitable fixed members (50) in the invention. Furthermore, blind holes (33, 42, 43, and 44) each defined on un-connected surfaces of plates (30 and 40) can face to the inside space (11) of the brick (1) upon assembling the bricks (1) such that the smoothness of brick surface can be sustained after assembling the bricks (1). Meanwhile, a top plate (20) without blind holes (not show) can replace the top plate (20) having blind holes (22) to achieve the smoothness of brick surface. That is, the top plate (20) can provide with blind holes (22) or not with holes (22) depending on its position in the assembled brick (1) construction.

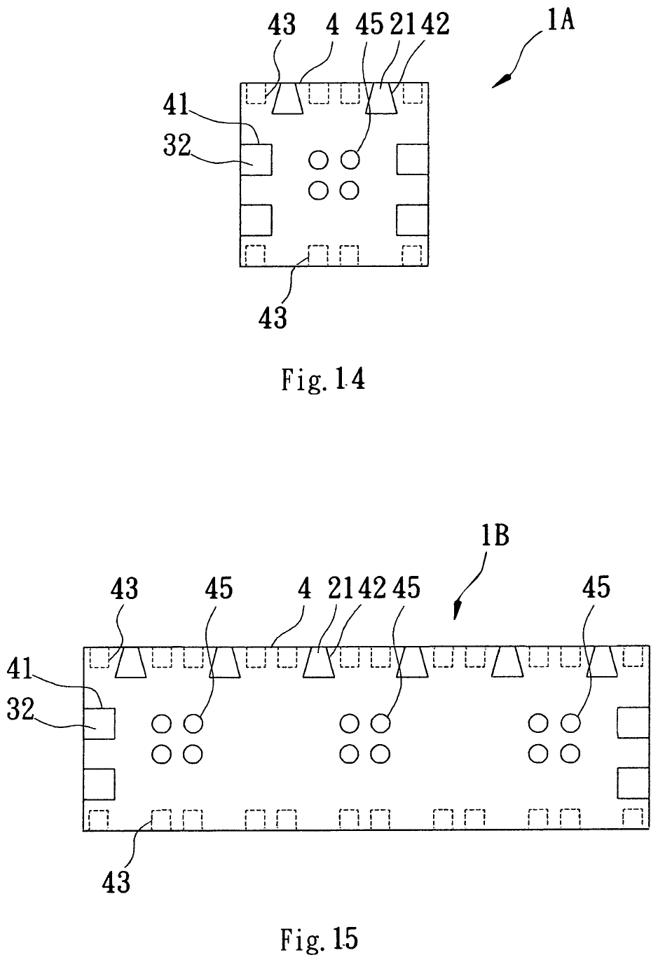

Now referring to FIG. 14, one embodiment of the wood brick (1A) in accordance with the invention can have the shorter length in the top plate (20). In this embodiment, comparing to the top plate (20) of bricks (1) in FIG. 1 through FIG. 13, the longitudinal length of top plate (20) of brick (1A) was cut off by 50%. As a result, the length in its longitudinal direction is equal to that in its transversal direction, that is, the shape of top plate (20) of this embodiment is square. Therefore, the top plate (20) of brick (1A) can achieve a square shape similar to that of the first lateral plate (30) (not shown). By this design of the top plate (20) shown in FIG. 14, the brick (1A) construction depths each in horizontal direction and perpendicular direction can match much more available construction sites without efforts in tailoring bricks (1A).

As mentioned above, the longitudinal length of top plate (20) of brick (1) can be two times of its transversal width. However, referring to FIG. 15, in comparison with brick (1), one embodiment of the brick (1B) in accordance with the invention can include a top plate (20) having a longitudinal length greater than its width by more than two times. In this embodiment, the longitudinal length is three time of the transversal width. Therefore, three pieces of brick (1B) can be positioned side by side along the longitudinal direction of the top plate (20) thereof and then be connected to the fourth brick (1B) with the first lateral plates (30) each of the three side-by-side bricks (1B) aligning the second lateral plate (40) of the fourth brick (1B). By this design of the top plate (20) shown in FIG. 15, the brick (1B) construction depths each in horizontal direction and perpendicular direction can match much more available construction sites without efforts in tailoring bricks (1B).

Summarizing, the structural design of the five wood plates of the assemblable brick in accordance with the invention allows the resulted brick be formed by such five plates with or without using additional glues. With using the fixed members, any two bricks can be wholly overlapped or partially lapped in perpendicular direction or horizontal direction such that any desired furniture formed by connecting the bricks can be constructed by a user at will to satisfy his need of DIY in house. The brick in accordance with the invention also can include characteristics in terms of low weight, quick assembling and environmental friendship.

It should be noted that the above descriptions of preferred embodiments in accordance with the invention, and especially the connection forms among the bricks, were illustrated for the sake of better explaining and understanding the aspects of the invention. Therefore, the scope and the spirit of the invention should depend on the following claims.

1. An assemblable wood brick, comprising:
a top plate being made of an approximately-rectangle wood plate having a suitable longitudinal length, a suitable transversal width and a suitable and even thickness, said top plate having four sides with two opposite longitudinal sides parallel extending in a longitudinal direction, two opposite transversal sides parallel extending in a transversal direction such that any two connecting adjacent sides of said four sides orthogonally connect to each other and two parallel opposite surfaces including a top surface and a bottom surface defined among said four sides, said two opposite longitudinal sides parallel extending in said longitudinal direction being of a same length larger than or equal to a same length of said two opposite transversal sides parallel extending in said transversal direction, wherein said two longitudinal sides respectively have at least one first dovetail tenon opposite to each other and said two transversal sides respectively have at least one second dovetail tenon opposite to each other;
two first lateral plates of a same shape, each of said first lateral plates being made of an approximately-square wood plate having four sides of a same length corresponding to said transversal width of said top plate and having a thickness equal to said thickness of said top plate such that any two adjacent connecting sides of said first lateral sides orthogonally connect to each other and having two parallel surfaces including an outer surface and an inner surface defined among said four sides of each one of said two first lateral plates, said four sides of each one of said first lateral plates comprising a top side, a bottom side parallel and opposite to said top side, a left side and a right side parallel and opposite to said left side,
wherein said two first lateral plates are oppositely disposed with said top side of one of said first lateral plates connecting to one of said transversal sides of said top plate while said top side of other one of said first lateral plates connects to other one of said transversal sides of said top plate, wherein said top side of each one of said first lateral plates has at least one top dovetail slut corresponding to said at least one second dovetail tenon of said top plate such that one of said corresponding transversally extending side of said top plate securely and vertically connects to one of said first lateral plates by joggling said dovetail slut and said dovetail tenon while other transversally extending side of said top plate securely and vertically connects to other one of said first lateral plate by joggling said dovetail slut and said corresponding dovetail tenon, and
wherein said first later plates respectively have at least one lateral slut defined on said left side and said right side such that said at least one lateral slut on said left side is opposite to said at least one lateral slut on said right side;
two second lateral plates of a same shape, each one of said second lateral plates being made of a approximately-rectangle plate having
four sides including a top side extending in a longitudinal direction, a bottom side extending in said longitudinal direction having a same length as a length of said top side and as said length of said longitudinal side of said top plate corresponding said top and bottom sides, two parallel transversal sides extending in a transversal direction and having a same length as said length of said left and right sides of said first lateral plates respectively corresponding to said two transversal sides wherein any two adjacent connecting sides of said second lateral plates orthogonally connect to each other, and
two surfaces including an outer surface and an inner surface defined among said four sides to define an even thickness of a same size as said thickness of said top plate and said first lateral plates, wherein said second lateral plates respectively include at least one dovetail slut defined on said top side and corresponding to said at least one dovetail tenon on one of said longitudinal side of said top plate and at least one protrusion defined on said transversal sides with said at least one protrusion of one of said transversal sides corresponding to said slut on said right or left side of one of said first lateral plate and said at least one protrusion of other said transversal sides corresponding to said right or left side of other one of said first lateral plate,
wherein said two second lateral plates are oppositely disposed with said top side of one of said two second lateral plates connecting to one of said longitudinal sides of said top plate and said top side of other said second lateral plates connecting to other longitudinal side of said top plate by joggling said at least one dovetail slut defined on said top side of each one of said second lateral plates to said at least one dovetail tenon of said top plate corresponding thereto and
wherein one of said transversal sides of one of said second lateral plates connects to said corresponding right or left side of one of said first lateral plates and other one of said transversal side of said one of said second lateral plates connects to said corresponding right or left side of other one of said second lateral plate and
meanwhile, one of said transversal sides of the other one of said second lateral plates connects to said corresponding right or left side of said other said first lateral plates and other one of said transversal sides of said other one of said second lateral plates connects to said corresponding right or left side of said other one of said second lateral plates such that said two second lateral plates each securely and orthogonally connects to said top plate and said two first lateral plates by joggling corresponding sides thereof, and
a space formed inside said wood brick by orthogonally connecting corresponding sides each of said top plate, said first lateral plates and said second lateral plates.

2. The assemblable wood brick of claim 1, wherein
said top plate includes at least one blind hole located on said top surface of said top plate such that said at least one blind hole on said top plates in one of any two said bricks corresponds to that on said top plate in other one of said any two bricks so as to stably connect said top plates each in said any two bricks by a fixed member corresponding to said blind holes each on said top plates;
said two second lateral plates respectively include at least one blind hole located on said outer surface thereof such that said at least one blind hole on said second lateral plate of one of any two wood bricks corresponds to said at least one blind hole on said second lateral plate of other one of said two wood bricks so as to stably connect said any two bricks by a fixed member corresponding to said at least one blind holes each on said second lateral plates; and
said two first lateral plates respectively include at least one blind hole defined on said outer surface thereof such that said at least one blind hole on said first lateral plate of one of any two wood bricks corresponds to that on other one of said any two wood brick so as to stably connect said any two bricks by a fixed member corresponding to said blind holes each on said any two bricks.

3. The assemblable wood brick of claim 2, wherein said at least one blind hole on said top plate corresponds to said at least one blind hole on said second lateral plate such that any two wood bricks stably connect to each other by a fixed member corresponding to said at least one blind holes respectively on said second lateral plate and said top plate.

4. The assemblable wood brick of claim 2, wherein said at least one blind hole on said top plate corresponds to said at least one blind hole on said first lateral plate such that any two bricks stably connect to each other by a fixed member corresponding to said blind holes each on said any two bricks.

5. The assemblable wood brick of claim 1, wherein said second lateral plates respectively include at least one blind hole located on said top side extending in said longitudinal direction and at least one blind hole located on said bottom side extending in said longitudinal direction such that said at least one blind hole on said top side of one of any two bricks corresponds to said at least one blind hole on said bottom side of other one of said two bricks so as to stably connect said two bricks by a fixed member corresponding both said blind holes each on said top side and said bottom side.

6. The assemblable wood brick of claim 2, wherein said at least one blind hole on said second lateral plate corresponds to said at least one blind hole on said first lateral plate such that any two bricks stably connect to each other by a fixed member corresponding both said blind holes each on said two bricks.

7. The assembalble wood brick of claim 1, wherein said longitudinal length of said top plate is two times of said transversal width thereof and both said top plate and said first lateral plates respectively include at least two blind holes, wherein said at least two blind holes on said top plate corresponds to said at least two blind holes on said first lateral plates so that any two bricks stably connect to each other by two fixed members corresponding to said blind holes each on said top plate and said first lateral plate.
